(19) United States
(12) Patent Application Publication
(10) Pub. No.: US 2005/0047704 A1
(43) Pub. Date: Mar. 3, 2005

(54) Optical semiconductor device, light phase control device, light intensity control device, and method of producing optical semiconductor device

(75) Inventor: Fumio Ohtake, Yamanashi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: EUDYNA DEVICES INC., Yamanashi (JP)

(21) Appl. No.: 10/923,829

(22) Filed: Aug. 24, 2004

(30) Foreign Application Priority Data
Aug. 25, 2003 (JP) 2003-300489

(51) Int. Cl. G02F 1/035

(52) U.S. Cl. 385/3; 385/40

(57) ABSTRACT

An optical semiconductor device that includes: an optical waveguide formed on a substrate; a modulation electrode and a conductive region that form a modulation region in the optical waveguide; and an interconnection pattern electrically connected to the modulation electrode. In this optical semiconductor device, the conductive region is formed in an area that excludes a region in which the interconnection pattern overlaps the optical waveguide.

### BACKGROUND OF THE INVENTION

1. Field of the Invention

The present invention generally relates to an optical semiconductor device, a light phase control device, a light intensity control device, and a method of producing the optical semiconductor device. More particularly, the present invention relates to an optical semiconductor device, a light phase control device, a light intensity control device, and a method of producing the optical semiconductor device that can control the phase and intensity of light in accordance with a modulation signal.

2. Description of the Related Art

Light phase control has conventionally been performed in various fields. Typically, split lights are controlled to have mutually different phases and are then combined with each other. In this manner, the intensity of light can be modulated.

FIG. 1 is a plan view of an optical modulator 100 to which a conventional light phase control technique is applied. As shown in FIG. 1, the optical modulator 100 includes a substrate 101 having optical waveguides 104, 105a, 105b, and 106 formed on one of its main surfaces (the upper surface). Each of these optical waveguides 104, 105a, 105b, and 106 is formed in a ridge-like fashion. The optical waveguide 104 at the input side branches into the optical waveguides 105a and 105b. The optical waveguides 105a and 105b are combined into the optical waveguide 106 at the output end.

Separate electrodes 102a, 102b, and 102c, which are electrically connected to a signal line 102, are formed over the optical waveguide 105a. The separate electrodes 102a, 102b, and 102c are modulation electrodes that input an electric field based on a modulation signal into the optical waveguide 105a so as to control the phase of light propagating through the optical waveguide 105a. These separate electrodes 102a, 102b, and 102c are arranged at predetermined intervals. With the separate electrodes 102a, 102b, and 102c, the propagation velocity of a modulation signal, which is a high-frequency signal entered into the signal line 102, is controlled so as to adjust the phase difference between the light propagating through the optical waveguide 105a and the modulation signal.

A conductive region 108 of a predetermined conductivity type extends under the optical waveguides 105a and 105b. Separate electrodes 103a, 103b, and 103c formed on the optical waveguide 105b are connected to a ground line 103. As a modulation signal is inputted into the signal line 102, an electric field based on the modulation signal is formed in the optical waveguide 105a located between the conductive region 108 and the separate electrodes 102a, 102b, and 102c. Thus, the phase of the light propagating through the optical waveguide 105a is controlled.

When a modulation signal is inputted into the signal line 102, an electric field that acts in the direction opposite to that in which the electric field is formed in the optical waveguide 105a is formed in the optical waveguide 105b. Thus, the phase of light propagating through the optical waveguide 105b is controlled in the direction opposite to that in which the light propagates through the optical waveguide 105a.

The light propagating through the optical waveguide 105a and the light propagating through the optical waveguide 105b are then combined and entered into the optical waveguide 106. Accordingly, the intensity of the light entered into the waveguide 106, i.e., the combined light, is controlled based on the above-mentioned phase difference.

In the above structure, the conductive region 108 has two functions mentioned below.

First, the conductive region 108 functions as an electrode that forms a capacitor between the conductive region 108 and each of the separate electrodes 102a, 102b, 102c, 103a, 103b, and 103c. The capacitors formed between the conductive region 108 and the separate electrodes 102a, 102b, 102c, 103a, 103b, and 103c, reduce the phase velocity of each high-frequency signal (modulation signal) inputted into the signal line 102. By doing so, the propagation velocity of the modulation signal can be matched with the phase velocity of light.

Secondly, the conductive region 108 functions as an electrode that generates electric fields in the opposite directions in the optical waveguides 105a and 105b. The conductive region 108 exists under both the optical waveguides 105a and 105b. When a modulation signal is inputted into the signal line 102, electric charges of the opposite polarities concentrate onto the region immediately below the optical waveguide 105a and the region immediately below the optical waveguide 105b. As a result, the direction of the electric field generated by the conductive region 108 and the separate electrodes 102a, 102b, and 102c, becomes opposite to the direction of the electric field formed by the conductive region 108 and the separate electrodes 103a, 103b, and 103c, as shown in FIG. 2. Accordingly, the phase control direction of the light propagating through the optical waveguide 105a can be made opposite to the phase control direction of the light propagating through the optical waveguide 105b. In short, a push-pull action can be caused between the optical waveguides 105a and 105b. In the push-pull action, voltages are applied to the two optical waveguides 105a and 105b so that the refractive index variations become equal to each other while the voltages applied the two optical waveguides 105a and 105b have opposite polarities. FIG. 2 shows the directions of the electric field resulting from the push-pull action. FIG. 2 is also a sectional view of the optical modulator 100 taken along the line F-F of FIG. 1.

Referring now to FIG. 2, the structure of the optical modulator 100 is further described. As shown in FIG. 2, the substrate 101 has a conductive layer 108a formed on a semi-insulating semiconductor substrate 101a. A lower cladding layer 101b, a core layer 101c, and an upper cladding layer 101d, which constitute the optical waveguide structure, are stacked on the conductive layer 108a. The separate electrodes 102a, 102b, 102c, 103a, 103b, and 103c are formed on the upper cladding layer 101d. In this structure, the conductive region 108 is formed by etching the conductive layer 108a along the outer peripheries of the optical waveguides 104, 105a, 105b, and 106. This Here, the etching is performed also on the lower cladding layer 101b and the core layer 101c formed on the conductive layer 108a. Each of the separate electrodes 102a, 102b, 102c, 103a, 103b, and 103c has an air-bridge shape, and bridges over a groove 110 formed by the etching, extending to the upper surface of the upper cladding layer 101d.

In the structure having the conductive region 108 extending along the optical waveguides 104, 105a, 105b, and 106, as shown in FIG. 1, the signal line 102 overlaps the conductive region 108 in an area where the optical waveguides 105a and 105b exist (the optical waveguides 104 and 106 may be included herein). The overlapping regions 109 may modulate light and make it difficult to perform precise phase control.

To avoid the above-mentioned problem, the signal line 102 may be arranged in such a manner as not to extend over the optical waveguides 105a and 105b. With such an arrangement, however, the characteristic impedance of the optical modulator 100 that inputs a modulation signal cannot easily be matched with the characteristic impedance at the output end (50 Ω, for example).

So as to reduce the undesirable modulation in the overlapping region 109, a structure shown in FIG. 3 has been suggested. An example of such a structure is disclosed in “High-Speed III-V Semiconductor Intensity Modulators” (Robert G. Walker, the IEEE Journal of Quantum Electronics, vol. 27, No. 3, pp. 654-667, March 1991). In FIG. 3, the same components as those of the optical modulator 100 shown in FIG. 1 are denoted by the same reference numerals as in FIG. 1, and explanation of them is omitted herein.

In the structure of an optical modulator 200 shown in FIG. 3, the signal line 102 of the optical modulator 100 is replaced with a signal line 202. The signal line 202 has relatively narrow lines 202a in the overlapping region 109, as shown in FIG. 3. With these narrow lines 202a, the total overlapping area between the signal line 202 (the lines 202a) and the conductive region 108 can be reduced, and unnecessary modulation can be restricted.

In the above-described structure having the narrow lines 202a, however, modulation signal reflections are caused in the narrow lines 202a, and a propagation loss is caused. This problem becomes even more conspicuous in a case where the frequency of the modulation signal exceeds 10 GHz. In such a case, high-precision optical modulation becomes difficult.

### SUMMARY OF THE INVENTION

It is therefore an object of the present invention to provide an optical semiconductor device, a light phase control device, a light intensity control device, and a method of producing the optical semiconductor device in which the above disadvantage is eliminated.

A more specific object of the present invention is to provide an optical semiconductor device, a light phase control device, a light intensity control device, and a method of producing the optical semiconductor device that can efficiently perform optical modulation with high precision.

The above objects of the present invention are achieved by an optical semiconductor device comprising: an optical waveguide formed on a substrate; a modulation electrode and a conductive region that form a modulation region in the optical waveguide; and an interconnection pattern electrically connected to the modulation electrode, the conductive region being formed in an area that excludes a region in which the interconnection pattern overlaps the optical waveguide.

The above objects of the present invention are also achieved by an optical semiconductor device comprising: an optical waveguide that is formed on a substrate; a plurality of modulation electrodes and a plurality of conductive regions that form a modulation region in the optical waveguide; and an interconnection pattern that is electrically connected to the modulation electrodes, the modulation electrodes being electrically separated from one another and corresponding to the conductive regions one by one, and the conductive regions being electrically separated from one another and formed in an area that excludes a region in which the interconnection pattern overlaps the optical waveguide.

The above objects of the present invention are also achieved by a light phase control device comprising: an optical waveguide formed on a substrate; a modulation electrode and a conductive region that form a modulation region in the optical waveguide; and an interconnection pattern electrically connected to the modulation electrode, the conductive region being formed in an area that excludes a region in which the interconnection pattern overlaps the optical waveguide, and a modulation signal being applied to the interconnection pattern, thereby controlling a phase of light propagating through the optical waveguide.

The above objects of the present invention are also achieved by a light phase control device comprising: an optical waveguide formed on a substrate; a plurality of modulation electrodes and a plurality of conductive regions that form a modulation region in the optical waveguide; and an interconnection pattern electrically connected to the modulation electrodes, the modulation electrodes being separated from one another, and corresponding to the conductive regions one by one, the conductive regions being electrically separated from one another, and being formed in an area that excludes a region in which the interconnection pattern overlaps the optical waveguide, and a modulation signal being applied to the interconnection pattern, thereby controlling the phase of light propagating through the optical waveguide.

The above objects of the present invention are also achieved by a light intensity control device comprising: a plurality of optical waveguides formed on a substrate; a modulation electrode and a conductive region that form a modulation region in the optical waveguides; and an interconnection pattern electrically connected to the modulation electrode, the conductive region being formed in an area that excludes a region in which the interconnection pattern overlaps the optical waveguides, and lights entered into the optical waveguides being subjected to phase control in the modulation region, and then being combined.

The above objects of the present invention are also achieved by a light intensity control device comprising: a plurality of optical waveguides formed on a substrate; a plurality of modulation electrodes and a plurality of conductive regions that form a modulation region in the optical waveguide; and an interconnection pattern electrically connected to the modulation electrodes, the modulation electrodes being separated from one another, and corresponding to the conductive regions one by one, the conductive regions being electrically separated from one another, and being formed in an area that excludes a region in which the interconnection pattern overlaps the optical waveguides, and lights entered into the optical waveguides being subjected to phase control in the modulation region, and then being combined.

The above objects of the present invention are also achieved by a method of producing an optical semiconductor device that includes an optical waveguide formed on a substrate, a modulation electrode and a conductive region for forming a modulation region in the optical waveguide, and an interconnection pattern electrically connected to the modulation electrode, the method comprising the step of: forming the conductive region in an area that excludes a region in which the interconnection pattern overlaps the optical waveguide.

The above objects of the present invention are also achieved by a method of producing an optical semiconductor device that includes an optical waveguide formed on a substrate, a plurality of modulation electrodes and a plurality of conductive regions for forming a modulation region in the optical waveguide, and an interconnection pattern electrically connected to the modulation electrodes, the method comprising the step of: forming the conductive regions in areas electrically separated from one another on the substrate, the areas excluding a region in which the interconnection pattern overlaps the optical waveguide.

### BRIEF DESCRIPTION OF THE DRAWINGS

Other objects, features and advantages of the present invention will become more apparent from the following detailed description when read in conjunction with the accompanying drawings, in which:

FIG. 1 is a plan view of an optical modulator to which a conventional light phase control technique is applied;

FIG. 2 is a sectional view of the optical modulator, taken along the line F-F of FIG. 1, and shows the directions of electric fields generated with a push-pull action;

FIG. 3 is a plan view of another optical modulator to which a conventional light phase control technique is applied;

FIG. 4 is a top view of an optical modulator in accordance with a first embodiment of the present invention;

FIG. 5 is a sectional view of the optical modulator, taken along the line A-A of FIG. 4;

FIG. 6A is a top view of a semi-insulating semiconductor substrate having a resist pattern and a conductive region formed thereon in a procedure for producing the optical modulator of the first embodiment;

FIG. 6B is a sectional view of the semi-insulating semiconductor substrate, taken along the line A1-A1 of FIG. 6A;

FIG. 7A is a top view of the semi-insulating semiconductor substrate having a lower cladding layer, an optical waveguide core layer, and an upper cladding layer stacked thereon in a procedure for producing the optical modulator of the first embodiment;

FIG. 7B is a sectional view of the semi-insulating semiconductor substrate, taken along the line A2-A2 of FIG. 7A;

FIG. 8A is a top view of the semi-insulating semiconductor substrate having the upper cladding layer etched along another resist pattern in a procedure for producing the optical modulator of the first embodiment;

FIG. 8B is a sectional view of the semi-insulating semiconductor substrate, taken along the line A3-A3 of FIG. 8A;

FIG. 9A is a top view of the semi-insulating semiconductor substrate having a signal line, a ground line, separate electrodes, and yet another resist pattern formed on the upper metal film and the optical core layer in a procedure for producing the optical modulator of the first embodiment;

FIGS. 9B and 9C are sectional views taken along a line A4-A4 shown in FIG. 9A:

FIG. 10 is a top view of an optical modulator in accordance with a second embodiment of the present invention;

FIG. 11 is a sectional view of the optical modulator, taken along the line B-B of FIG. 10;

FIG. 12A is a top view of the semi-insulating semiconductor substrate having a resist pattern and separate conductive regions formed thereon in a procedure for producing the optical modulator of the second embodiment; and

FIG. 12B is a sectional view of the semi-insulating semiconductor substrate, taken along the line B1-B1 of FIG. 12A.

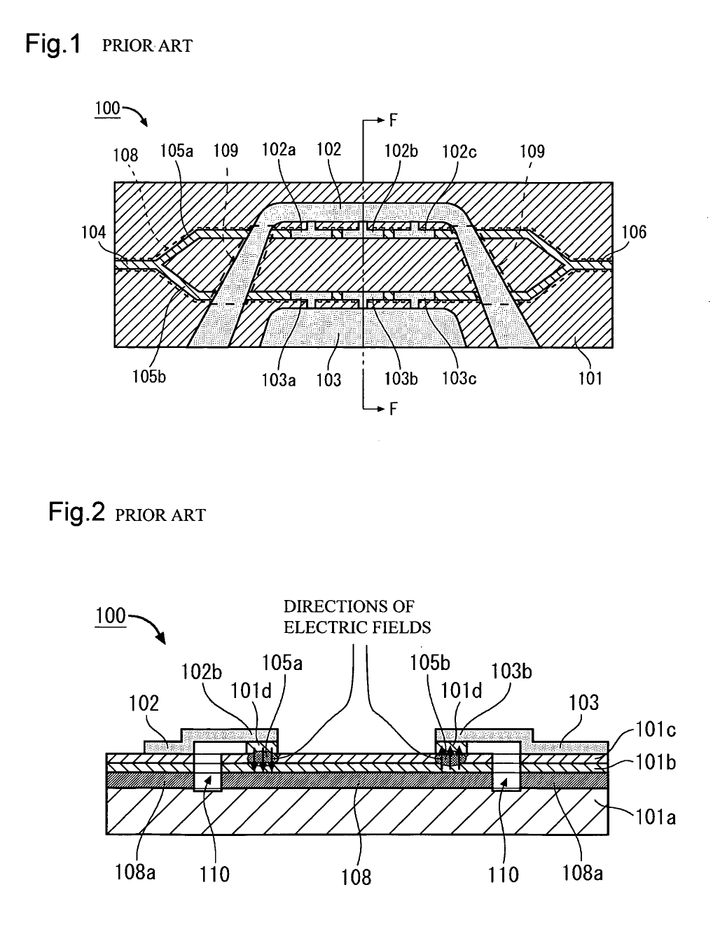

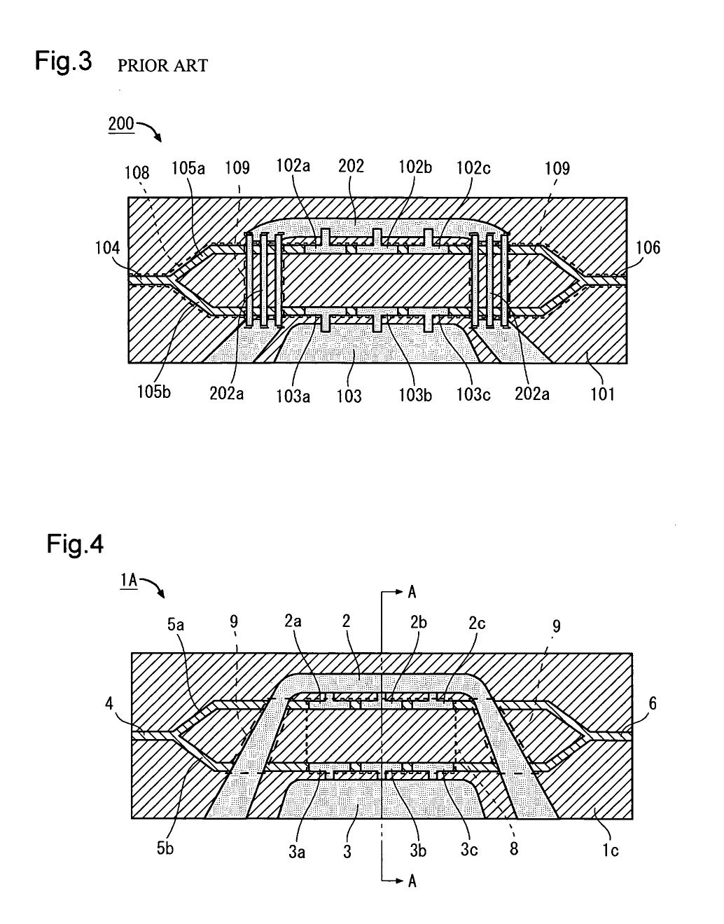

### DESCRIPTION OF THE PREFERRED EMBODIMENTS

A description will now be given of preferred embodiments of the present invention with reference to the accompanying drawings.

(First Embodiment)

Referring first to FIGS. 4 and 5, a first embodiment of the present invention is described. FIG. 4 is a top view of an optical modulator 1A in accordance with this embodiment. FIG. 5 is a sectional view of the optical modulator 1A taken along the line A-A of FIG. 4.

As shown in FIG. 4, the optical modulator 1A is a Mach-Zehnder optical modulator, which has optical waveguides 4, 5a, 5b, and 6 formed on a main surface (the upper surface) of a substrate 1. Each of the optical waveguides 4, 5a, 5b, and 6 is formed in a ridge structure. However, the optical waveguides of the present invention are not limited to ridge-like waveguides, and it is possible to employ other types of optical waveguide structures.

The optical waveguide 4 located at the input end branches into several optical waveguides (the two optical waveguides 5a and 5b in this embodiment) in the center area of the upper surface of the substrate 1. Accordingly, the optical waveguides 5a and 5b are branch waveguides of the optical waveguide 4. The optical waveguides 5a and 5b that are the branch waveguides are combined into the single optical waveguide 6 at the output end on the upper surface of the substrate 1. Accordingly, the optical waveguides 5a and 5b are combined into another optical waveguide at a later stage than a modulation region (described later) in the propagation direction of light.

As shown in FIG. 5, the substrate 1 has an embedded-type conductive region 8 formed in a part of the upper surface of a semi-insulating semiconductor substrate 1a. A lower cladding layer 1b, an optical waveguide core layer 1c, and an upper cladding layer 1d that constitute the optical waveguide structure are stacked on the upper surface of the semi-insulating semiconductor substrate 1a including the conductive region 8.

The semi-insulating semiconductor substrate 1a may be a GaAs (gallium arsenide) substrate or an InP (indium phosphide) substrate that is not doped with an impurity. However, the semi-insulating semiconductor substrate 1a of this embodiment is not limited to the above examples, and even an insulating semiconductor substrate may be employed as long as the substrate material exhibits excellent lattice matching with the optical waveguide structure (especially with the lower cladding layer 1b) formed thereon.

The conductive region 8 can be formed as an n⁺-type semiconductor region by ion implantation of an impurity such as silicon (Si) into a predetermined region (described later) on the semi-insulating semiconductor substrate 1a. In the present invention, the conductive region 8 may be a p⁺-type semiconductor region, instead of an n⁺-type semiconductor region. However, an n⁺-type semiconductor is more preferable, having a higher conductivity, a smaller light absorptivity, and a lower impurity diffusibility.

The optical waveguide core layer 1c may be a semiconductor mixed-crystal layer of GaAs or InGaAsP (indium, gallium, arsenide, phosphide), for example. With a semiconductor mixed-crystal material, the optical waveguide core layer 1c can be formed as a multiple-quantum well (MQW) layer.

The lower cladding layer 1b and the upper cladding layer 1d may be undoped AlGaAs or InP cladding layers, or p- or n-doped InP layers, for example. The cladding layers 1b and 1d may be made of any semiconductor mixed-crystal material having a smaller refractive index than the material of the core layer 1c. The material for the lower cladding layer 1b and the upper cladding layer 1d should preferably be determined by its lattice matching property with the semi-insulating semiconductor substrate 1a and the optical waveguide core layer 1c.

Referring back to FIG. 4, the other parts of the structure are described. As shown in FIG. 4, an interconnection pattern that includes a signal line 2 and a ground line 3 is formed on the upper surface of the substrate 1. On the upper surface of the substrate 1, the ground line 3 is formed on a first side of the optical waveguide 5b opposite to a second side thereof on which the optical waveguide 5a is formed (the first side may be referred to as the side of the optical waveguide 5b on the upper surface of the substrate 1). The signal line 2 is formed on a first side of the optical waveguide 5a opposite to a second side thereof on which the optical waveguide 5b is formed (the first side may be referred to as the side of the optical waveguide 5a on the upper surface of the substrate 1). The signal line 2 has the modulation signal input end and output end, which ends extend to the same side as the ground line 3. Accordingly, the signal line 2 is arranged to extend over the optical waveguides 5a and 5b (the optical waveguide 4 and/or the optical waveguide 6 may be included herein). As the input and output ends of the signal line 2 are extended to the same side as the input and output ends of the ground line 3, the characteristic impedance of the optical modulator 1A can be easily controlled. The same effects as the above can also be achieved with a structure in which the ground line 3 extends over the optical waveguides 5a and 5b (the optical waveguide 4 and/or the optical waveguide 6 may be included herein) and is extended to the same side as the signal line 2.

Separate electrodes 2a, 2b, and 2c are electrically connected to the signal line 2 on the side of the optical waveguide 5a. The separate electrodes 2a, 2b, and 2c, together with the conductive region 8 (described later), form a “modulation region” in the optical waveguide 5a. More specifically, an electric field based on a modulation signal inputted into the signal line 2 is entered into the optical waveguide 5a, so as to control the phase of light propagating through the optical waveguide 5a. Here, the “modulation region” is a region to be used to control the phase of propagating light.

In this embodiment, the separate electrodes 2a, 2b, and 2c are formed on the upper cladding layer 1d of a mesa structure, and form a capacitor between the conductive region 8 and each of the separate electrodes 2a, 2b, and 2c. With this arrangement, the electric field generated based on the modulation signal inputted into the signal line 2 is entered into the optical waveguide 5a.

The separate electrodes 2a, 2b, and 2c are arranged at predetermined intervals, so as to control the propagation velocity of the modulation signal that is a high-frequency signal inputted into the signal line 2, and to adjust the phase difference between the light propagating through the optical waveguide 5a and the modulation signal. The predetermined intervals are determined by the capacitance of the capacitor formed between the conductive region 8a and each of the separate electrodes 2a, 2b, and 2c.

Separation electrodes 3a, 3b, and 3c are electrically connected to the ground line 3 at the locations corresponding to the separate electrodes 2a, 2b, and 2c. The separate electrodes 3a, 3b, and 3c, together with the conductive region 8, form a modulation region in the optical waveguide 5b. More specifically, an electric field based on the potential of a modulation signal applied to the signal line 2 via the conductive region 8 is entered into the optical waveguide 5b, so as to control the phase of light propagating through the optical waveguide 5b.

In this embodiment, the separate electrodes 3a, 3b, and 3c are formed on the upper cladding layer 1d of a mesa structure, like the separate electrodes 2a, 2b, and 2c. A capacitor is formed between the conductive region 8 and each of the separate electrodes 3a, 3b, and 3c. With this arrangement, the electric field based on the modulation signal via the conductive region 8 is entered into the optical waveguide 5b.

The direction of the electric field generated between the conductive region 8 and the separate electrodes 2a, 2b, and 2c is always opposite from the direction of the electric field generated between the conductive region 8 and the separate electrodes 3a, 3b, and 3c, as shown in FIG. 5. The potential of each of the separate electrodes 3a, 3b, and 3c connected to the ground line 3 is constantly 0 V.

In this embodiment, the conductive region on the side of the separate electrodes 2a, 2b, and 2c, and the conductive region on the side of the separate electrodes 3a, 3b, and 3c, constitute the single conductive region 8. More specifically, the pairs of separate electrodes 2a and 3a, 2b and 3b, and 2c and 3c, and the conductive region 8, are arranged to extend over the optical waveguides 5a and 5b, so that a push-pull action is caused between the optical waveguides 5a and 5b. Accordingly, the intensity of input light can be controlled with a low voltage. Here, a push-pull action involves application of voltage to the two optical waveguides 5a and 5b in such a manner that that the variation in the refractive index of the optical waveguide 5a and the variation in the refractive index of the optical waveguide 5b are the same in size, but opposite in plus-minus sign.

The signal line 2, the ground line 3, the separate electrodes 2a, 2b, 2c, 3a, 3b, and 3c can be formed with gold film, for example. However, any other conductive material (especially a metal) with a relatively low resistivity may be employed for those components.

Next, the conductive region 8 of this embodiment is described. The conductive region 8 is formed through ion implantation of an impurity such as silicon (Si) into a predetermined region on the semi-insulating semiconductor substrate 1a, as described earlier. In this embodiment, the ion implantation is performed on the predetermined region that excludes the overlapping regions 9 in which the signal line 2 overlaps the optical waveguides 5a and 5b (as well as the optical waveguide 4 and/or the optical waveguide 6, if necessary). Thus, the conductive region 8 is formed outside the overlapping regions 9 in this embodiment.

With the above described structure, phase control outside the modulation region can be prevented, when the phases of light propagating through the optical waveguides 5a and 5b are controlled in the opposite directions from each other after the light in the optical waveguide 4 branches into the optical waveguides 5a and 5b. Thus, phase control and optical modulation can be performed with high precision.

Next, a method of producing the optical modulator 1A of the first embodiment is described, with reference to the accompanying drawings.

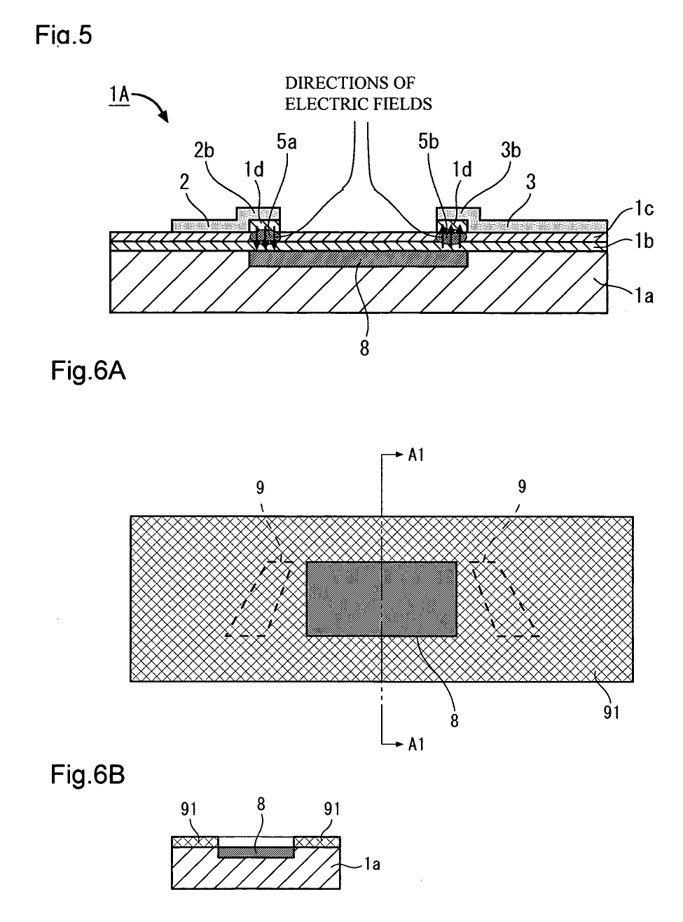

In this method of producing the optical modulator 1A of this embodiment, a resist pattern 91 is first formed by a photolithography technique on the upper surface of the semi-insulating semiconductor substrate 1a excluding the predetermined region, as shown in FIGS. 6A and 6B. Ion implantation of an impurity is then performed to form the conductive region 8. FIG. 6A is a top view of the semi-insulating semiconductor substrate 1a having the resist pattern 91 and the conductive region 8 formed thereon. FIG. 6B is a sectional view of the semi-insulating semiconductor substrate 1a taken along the line A1-A1 of FIG. 6A. In this description, the semi-insulating semiconductor substrate 1a is an undoped GaAs substrate, and the impurity implanted in the predetermined region is silicon. Thus, the n⁺-type conductive region 8 is formed. Here, the predetermined region excludes the overlapping regions 9, as mentioned earlier, but includes the modulation region (corresponding to the regions located under the separate electrodes 2a, 2b, 2c, 3a, 3b, and 3c). In FIG. 6A, the overlapping regions 9 are indicated by broken lines for reference.

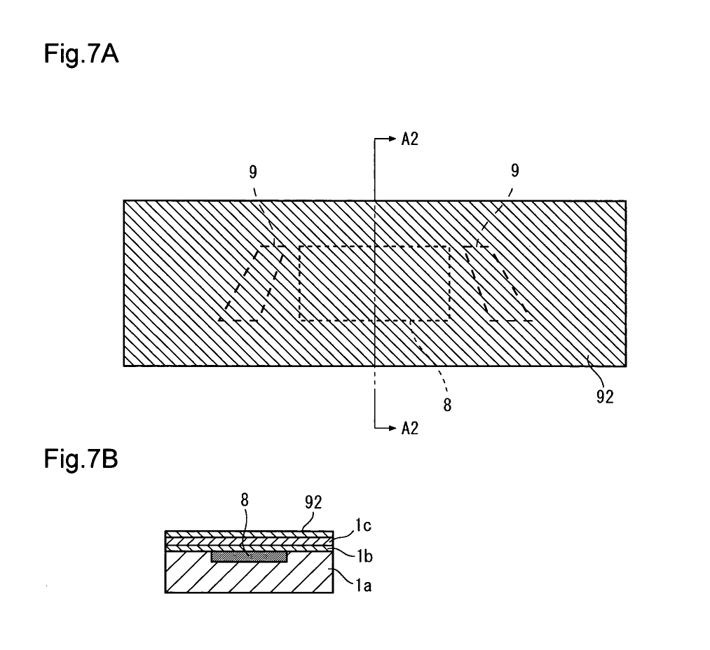

After the resist pattern 91 is removed from the upper surface of the semi-insulating semiconductor substrate 1a, an AlGaAs layer that lattice-matches with GaAs, for example, is epitaxially grown as the lower cladding layer 1b on the exposed upper surface of the semi-insulating semiconductor substrate 1a, as shown in FIGS. 7A and 7B. A GaAs layer that lattice-matches with AlGaAs, for example, is then epitaxially grown as the optical waveguide core layer 1c on the lower cladding layer 1b. An AlGaAs layer that lattice-matches with GaAs is further epitaxially grown as an upper cladding layer 92 on the optical waveguide core layer 1c. FIG. 7A is a top view of the semi-insulating semiconductor substrate 1a having the lower cladding layer 1b, the optical waveguide core layer 1c, and the upper cladding layer 92 stacked thereon. FIG. 7B is a sectional view of the semi-insulating semiconductor substrate 1a taken along the line A2-A2 of FIG. 7A. The upper cladding layer 92 is yet to be processed to form the upper cladding layer 1d.

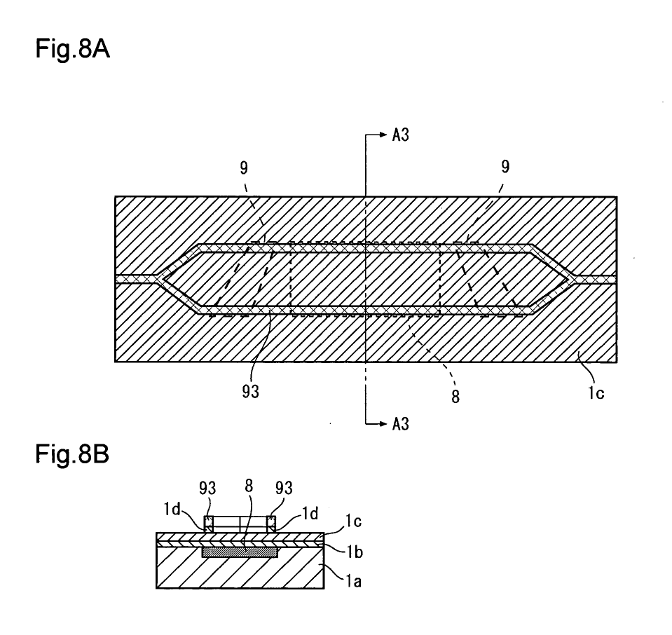

A resist pattern 93 is next formed by a photolithography technique on the upper cladding layer 92, as shown in FIGS. 8A and 8B. Etching is then performed on the upper cladding layer 92 by a reactive ion etching (RIE) technique or the like, so as to form the upper cladding layer 1d that is in conformity with the shapes of the optical waveguides 4, 5a, 5b, and 6. FIG. 8A is a top view of the semi-insulating semiconductor substrate 1a having the upper cladding layer 92 etched in conformity with the resist pattern 93. FIG. 8B is a sectional view of the semi-insulating semiconductor substrate 1a taken along the line A3-A3 of FIG. 8A.

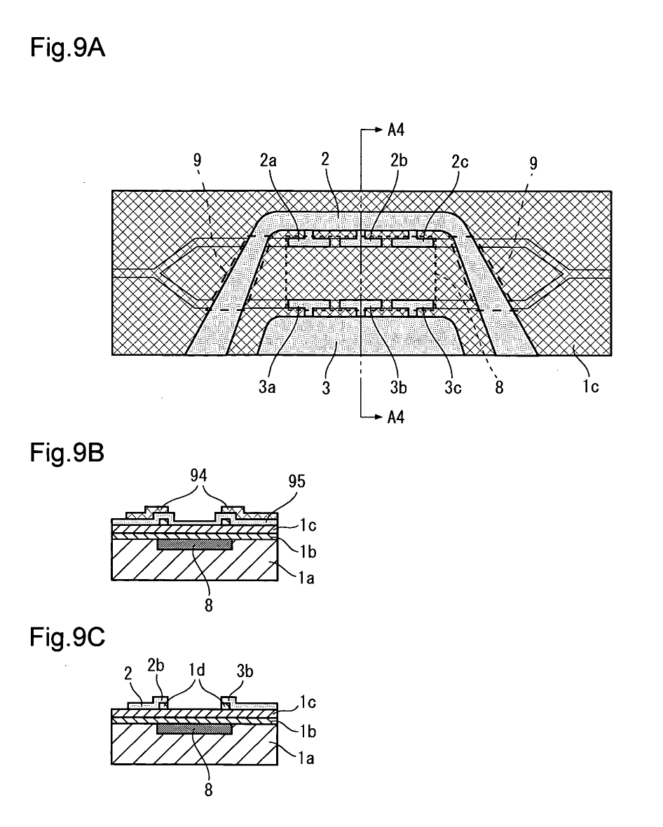

After the resist pattern 93 remaining on the upper cladding layer 1d is removed, a metal film 95 such as gold film is formed on the entire surface by a vapor phase deposition technique or a sputtering technique, as shown in FIGS. 9A and 9B. A resist pattern 94 is then formed by a photolithography technique on the regions corresponding to the signal line 2, the ground line 3, the separate electrodes 2a, 2b, 2c, 3a, 3b, and 3c, on the upper cladding layer 1d and the optical waveguide core layer 1c. A metal pattern that includes the signal line 2, the ground line 3, and the separate electrodes 2a, 2b, 2c, 3a, 3b, and 3c, is then formed by an ion milling technique or a RIE technique. In this manner, the signal line 2, the separate electrodes 2a, 2b, and 2c, the ground line 3, and the separate electrodes 3a, 3b, and 3c, are integrally formed through a single process. FIG. 9A is a top view of the semi-insulating semiconductor substrate 1a having the signal line 2, the ground line 3, the separate electrodes 2a, 2b, 2c, 3a, 3b, and 3c formed on the upper cladding layer 1d and the optical waveguide core layer 1c. FIG. 9B is a sectional view of the semi-insulating semiconductor substrate 1a having the metal film 95 formed on the entire surface and the resist pattern 94 formed by a photolithography technique taken along the line A4-A4 of FIG. 9A. FIG. 9C is a sectional view of the semi-insulating semiconductor substrate 1a after the etching on the metal film 95 taken along the line A4-A4 of FIG. 9A. Although the signal line 2, the ground line 3, and the separate electrodes 2a, 2b, 2c, 3a, 3b, and 3c are formed with gold film in this embodiment, they are not limited to that material. Any conductive material may be employed for the signal line 2, the ground line 3, and the separate electrodes 2a, 2b, 2c, 3a, 3b, and 3c, as long as it exhibits a sufficiently low resistivity with respect to a high-frequency modulation signal. Also, the signal line 2, the separate electrodes 2a, 2b, and 2c, the ground line 3, and the separate electrodes 3a, 3b, and 3c are integrally formed through a single process in this embodiment. However, it is also possible to process the signal line 2, the separate electrodes 2a, 2b, and 2c, the ground line 3, and the separate electrodes 3a, 3b, and 3c separately from one another.

The resist pattern 94 is then removed to obtain the optical modulator 1A shown in FIGS. 4 and 5.

Although the conductive region 8 of the optical modulator 1A is produced by implanting ions in the upper surface of the semi-insulating semiconductor substrate 1a in this embodiment, it may also be produced by forming a high-resistance layer on the semi-insulating semiconductor substrate 1a and making part of the high-resistance layer conductive. Further, the conductive region 8, which is formed on the upper surface of the semi-insulating semiconductor substrate 1a in this embodiment, may be formed inside the semi-insulating semiconductor substrate 1a. The conductive region 8 may also be formed on the bottom surface by selective ion implantation, or may be formed physically on the bottom surface of the semi-insulating semiconductor substrate 1a.

Through the above described procedures of this embodiment, the conductive region 8 can be formed in the region excluding at least the overlapping regions 9 in which the signal line 2 overlaps the optical waveguides 5a and 5b.

(Second Embodiment)

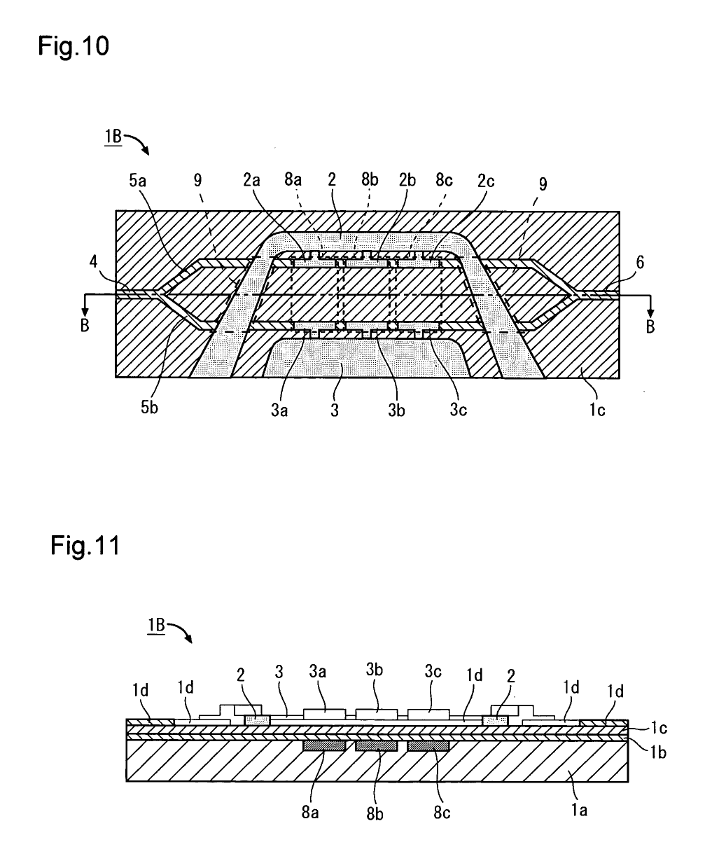

Next, a second embodiment of the present invention is described, with reference to the accompanying drawings. FIG. 10 is a top view of an optical modulator 1B in accordance with this embodiment. FIG. 11 is a sectional view of the optical modulator 1B taken along the line B-B of FIG. 10. In the following description, the same components as those of the first embodiment are denoted by the same reference numerals as those of the first embodiment, and explanation of them is omitted.

As shown in FIGS. 10 and 11, the optical modulator 1B has the same structure as the optical modulator 1A of the first embodiment, except that the conductive region 8 formed on the upper surface of the semi-insulating semiconductor substrate 1a is replaced with conductive regions 8a, 8b, and 8c that are electrically separated from one another. The conducive regions 8a, 8b, and 8c correspond to the pair of separate electrodes 2a and 3a, the pair of separate electrodes 2b and 3b, and the pair of separate electrodes 2c and 3c, respectively.

The electric field formed by the capacitor including the separate electrode 3a should preferably be formed based on the electric field formed by the capacitor including the separate electrode 2a. In the case where the conductive region 8 shared among the several pairs of separate electrodes (2a and 3a, 2b and 3b, and 2c and 3c) is used as in the first embodiment, a modulation signal inputted into one of the pairs of separate electrodes (2a and 3a, 2b and 3b, or 2c and 3c) might enter another pair of separate electrodes via the conductive region 8, i.e., crosstalk might be caused. When crosstalk is caused with a modulation signal, it is difficult to perform phase control in accordance with the propagation velocity of light. Without accurate phase control, it is also difficult to accurately modulate the light intensity. To counter this problem, the conductive regions 8a, 8b, and 8c are employed to cope with the pairs of separate electrodes 2a and 3a, 2b and 3b, and 2c and 3c, respectively. With this structure, modulation signal crosstalk via a conductive region can be prevented, and accurate light phase control and light intensity modulation can be performed. The other aspects of this embodiment are the same as those of the first embodiment, and therefore, explanation of them is omitted herein.

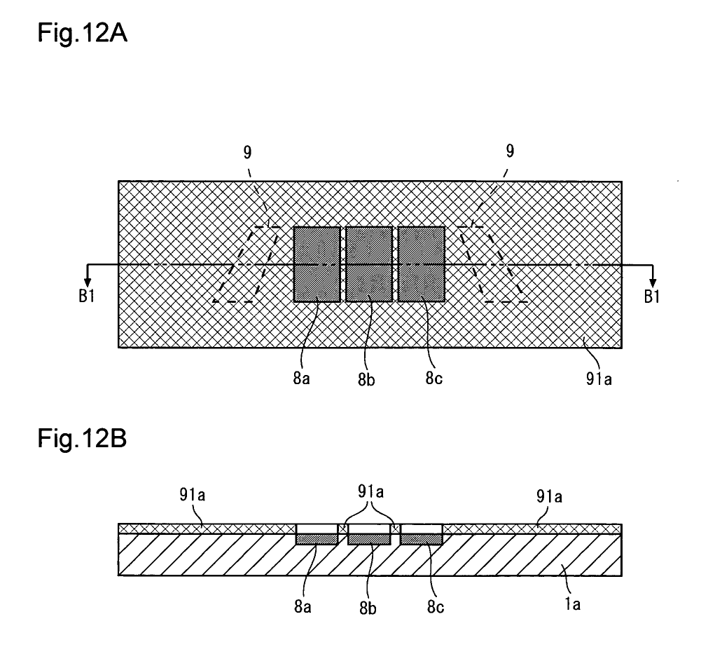

Referring now to FIGS. 12A and 12B, a method of producing the optical modulator 1B of this embodiment is described in detail.

The method of producing the optical modulator 1B is the same as the method of producing the optical modulator 1A of the first embodiment, except that the shape of the conductive region 8 formed through the process shown in FIGS. 6A and 6B, i.e., the shape of the resist pattern 91 formed on the semi-insulating semiconductor substrate 1a, is changed to the shape of a resist pattern 91a shown in FIGS. 12A and 12B. Ion implantation with an impurity is performed on the resist pattern 91a, so as to form the conductive regions 8a, 8b, and 8c that are electrically separated from one another and correspond to the pairs of separate electrodes 2a and 3a, 2b and 3b, and 2c and 3c, respectively. FIG. 12A is a top view of the semi-insulating semiconductor substrate 1a having the resist pattern 91a and the conductive regions 8a, 8b, and 8c formed thereon. FIG. 12B is a sectional view of the semi-insulating semiconductor substrate 1a taken along the line B1-B1 of FIG. 12A. The other production procedures and materials employed in this embodiment are the same as those in the first embodiment, and therefore, explanation of them is omitted herein.

The conductive regions 8a, 8b, and 8c may be formed by providing an air gap or a high-resistance region around each of the regions to be the conductive regions 8a, 8b, and 8c.

The present invention described so far through the first and second embodiments can be applied to not only optical modulators that control the intensity of light after the phases of divided light are combined, but also to various optical devices for controlling light phases.

Finally, the above-mentioned present invention is summarized as follows.

The optical semiconductor device includes: an optical waveguide formed on a substrate; a modulation electrode and a conductive region that form a modulation region in the optical waveguide; and an interconnection pattern electrically connected to the modulation electrode, the conductive region being formed in an area that excludes a region in which the interconnection pattern overlaps the optical waveguide. With this structure, it is possible to prevent optical modulation from taking place in an undesired region on the substrate and to realize highly precise optical modulation. There is no need to narrow the interconnection line in a position in which it overlaps optical waveguide. It is thus possible to restrain reflection of the modulation signal entered into the interconnection pattern and reduce loss of the modulation signal. Thus, highly precise optical modulation can be efficiently implemented.

According to another aspect of the present invention, the optical semiconductor device includes: an optical waveguide that is formed on a substrate; a plurality of modulation electrodes and a plurality of conductive regions that form a modulation region in the optical waveguide; and an interconnection pattern that is electrically connected to the modulation electrodes, the modulation electrodes being electrically separated from one another and corresponding to the conductive regions one by one, and the conductive regions being electrically separated from one another and formed in an area that excludes a region in which the interconnection pattern overlaps the optical waveguide. With this structure, it is possible to prevent optical modulation from taking place in an undesired region on the substrate and to realize highly precise optical modulation. There is no need to narrow the interconnection line in a position in which it overlaps optical waveguide. It is thus possible to restrain reflection of the modulation signal entered into the interconnection pattern and reduce loss of the modulation signal. Thus, highly precise optical modulation can be efficiently implemented. Additionally, the use of separate modulation electrodes enables the propagation velocity of the modulation signal to match the propagation velocity of light, and improves the precision of optical modulation. Since each of the conductive regions is associated with the respective separate modulation electrode, the crosstalk between the signals in the adjacent modulation regions can be restrained and the precision of optical modulation can be further improved.

The optical semiconductor device may be configured so that the optical waveguide includes branch waveguides.

The optical semiconductor device may be configured so that the optical waveguide is combined with another optical waveguide at a later stage than the modulation region in a propagation direction of light propagating through the optical waveguide.

The optical semiconductor device may be configured so that the modulation electrode and the conductive region are provided for branch optical waveguides of said optical waveguide. In this case, preferably, the conductive region exists under each of the branch optical waveguides. Thus, the push-pull action between the branch optical waveguides can be achieved, and the control of the light intensity can be efficiently controlled with a relatively low voltage.

The optical semiconductor device may be configured so that: the optical waveguides include branch optical waveguides; a first part of the interconnection pattern associated to one of the branch optical waveguides is supplied with the modulation signal; and a second part of the interconnection pattern associated with another one of the branch optical waveguides is supplied with a ground potential.

The optical semiconductor device may be configured so that the first and second part of the interconnection pattern extend outward from an identical side on the substrate. The first part of the interconnection pattern may be a signal line, and the second part thereof may be a ground line. With the above-mentioned structure, the characteristic impedance of the optical semiconductor device can be adjusted more easily.

The optical semiconductor device may be configured so that the modulation region is formed in the optical waveguide located between the first part of the interconnection pattern to which the modulation signal is applied and the second part of the interconnection pattern to which the ground potential is applied.

The optical semiconductor device may be configured so that the conductive regions are electrically separated from one another by at least one of an air gap, an insulting region, and a region with a higher resistance than the conductive regions.

The optical semiconductor device may be configured so that the modulation electrodes are arranged at such intervals that the propagation velocity of a modulation signal propagating through the interconnection pattern is matched with the propagation velocity of light propagating through the optical waveguide. It is thus possible to pull the modulation signal and the light in phase and improve the precision of optical modulation.

The optical semiconductor device may be configured so that the optical waveguide is of a ridge type. The optical semiconductor device may be configured so that the conductive region is formed with a conductor or a semiconductor doped with an impurity.

According to yet another aspect of the present invention, the light phase control device includes: an optical waveguide formed on a substrate; a modulation electrode and a conductive region that form a modulation region in the optical waveguide; and an interconnection pattern electrically connected to the modulation electrode, the conductive region being formed in an area that excludes a region in which the interconnection pattern overlaps the optical waveguide, and a modulation signal being applied to the interconnection pattern, thereby controlling a phase of light propagating through the optical waveguide. With this structure, it is possible to prevent optical modulation from taking place in an undesired region on the substrate and to realize highly precise optical modulation. There is no need to narrow the interconnection line in a position in which it overlaps optical waveguide. It is thus possible to restrain reflection of the modulation signal entered into the interconnection pattern and reduce loss of the modulation signal. Thus, highly precise optical modulation can be efficiently implemented.

According to a further aspect of the present invention, the light phase control device includes: an optical waveguide formed on a substrate; a plurality of modulation electrodes and a plurality of conductive regions that form a modulation region in the optical waveguide; and an interconnection pattern electrically connected to the modulation electrodes, the modulation electrodes being separated from one another, and corresponding to the conductive regions one by one, the conductive regions being electrically separated from one another, and being formed in an area that excludes a region in which the interconnection pattern overlaps the optical waveguide, and a modulation signal being applied to the interconnection pattern, thereby controlling the phase of light propagating through the optical waveguide. With this structure, it is possible to prevent optical modulation from taking place in an undesired region on the substrate and to realize highly precise optical modulation. There is no need to narrow the interconnection line in a position in which it overlaps optical waveguide. It is thus possible to restrain reflection of the modulation signal entered into the interconnection pattern and reduce loss of the modulation signal. Thus, highly precise optical modulation can be efficiently implemented. Additionally, the use of separate modulation electrodes enables the propagation velocity of the modulation signal to match the propagation velocity of light, and improves the precision of optical modulation. Since each of the conductive regions is associated with the respective separate modulation electrode, the crosstalk between the signals in the adjacent modulation regions can be restrained and the precision of optical modulation can be further improved.

According to a still further aspect of the present invention, the light intensity control device includes: a plurality of optical waveguides formed on a substrate; a modulation electrode and a conductive region that form a modulation region in the optical waveguides; and an interconnection pattern electrically connected to the modulation electrode, the conductive region being formed in an area that excludes a region in which the interconnection pattern overlaps the optical waveguides, and lights entered into the optical waveguides being subjected to phase control in the modulation region, and then being combined. With this structure, it is possible to prevent optical modulation from taking place in an undesired region on the substrate and to realize highly precise optical modulation. There is no need to narrow the interconnection line in a position in which it overlaps optical waveguide. It is thus possible to restrain reflection of the modulation signal entered into the interconnection pattern and reduce loss of the modulation signal. Thus, highly precise optical modulation can be efficiently implemented.

According to another aspect of the present invention, the light intensity control device includes: a plurality of optical waveguides formed on a substrate; a plurality of modulation electrodes and a plurality of conductive regions that form a modulation region in the optical waveguide; and an interconnection pattern electrically connected to the modulation electrodes, the modulation electrodes being separated from one another, and corresponding to the conductive regions one by one, the conductive regions being electrically separated from one another, and being formed in an area that excludes a region in which the interconnection pattern overlaps the optical waveguides, and lights entered into the optical waveguides being subjected to phase control in the modulation region, and then being combined. With this structure, it is possible to prevent optical modulation from taking place in an undesired region on the substrate and to realize highly precise optical modulation. There is no need to narrow the interconnection line in a position in which it overlaps optical waveguide. It is thus possible to restrain reflection of the modulation signal entered into the interconnection pattern and reduce loss of the modulation signal. Thus, highly precise optical modulation can be efficiently implemented. Additionally, the use of separate modulation electrodes enables the propagation velocity of the modulation signal to match the propagation velocity of light, and improves the precision of optical modulation. Since each of the conductive regions is associated with the respective separate modulation electrode, the crosstalk between the signals in the adjacent modulation regions can be restrained and the precision of optical modulation can be further improved.

According to still another aspect of the present invention, the method of producing an optical semiconductor device that includes an optical waveguide formed on a substrate, a modulation electrode and a conductive region for forming a modulation region in the optical waveguide, and an interconnection pattern electrically connected to the modulation electrode, the method comprising the step of: forming the conductive region in an area that excludes a region in which the interconnection pattern overlaps the optical waveguide. With this structure, it is possible to prevent optical modulation from taking place in an undesired region on the substrate and to realize highly precise optical modulation. There is no need to narrow the interconnection line in a position in which it overlaps optical waveguide. It is thus possible to restrain reflection of the modulation signal entered into the interconnection pattern and reduce loss of the modulation signal. Thus, highly precise optical modulation can be efficiently implemented.

According to yet another aspect of the present invention, the method of producing an optical semiconductor device that includes an optical waveguide formed on a substrate, a plurality of modulation electrodes and a plurality of conductive regions for forming a modulation region in the optical waveguide, and an interconnection pattern electrically connected to the modulation electrodes, the method comprising the step of: forming the conductive regions in areas electrically separated from one another on the substrate, the areas excluding a region in which the interconnection pattern overlaps the optical waveguide. With this structure, it is possible to prevent optical modulation from taking place in an undesired region on the substrate and to realize highly precise optical modulation. There is no need to narrow the interconnection line in a position in which it overlaps optical waveguide. It is thus possible to restrain reflection of the modulation signal entered into the interconnection pattern and reduce loss of the modulation signal. Thus, highly precise optical modulation can be efficiently implemented. Additionally, the use of separate modulation electrodes enables the propagation velocity of the modulation signal to match the propagation velocity of light, and improves the precision of optical modulation. Since each of the conductive regions is associated with the respective separate modulation electrode, the crosstalk between the signals in the adjacent modulation regions can be restrained and the precision of optical modulation can be further improved.

Although a few preferred embodiments of the present invention have been shown and described, it would be appreciated by those skilled in the art that changes may be made in these embodiments without departing from the principles and spirit of the invention, the scope of which is defined in the claims and their equivalents.

The present invention is based on Japanese Patent Application No. 2003-300489 filed on Aug. 25, 2004, the entire contents of which are hereby incorporated by reference.

1. An optical semiconductor device comprising:
an optical waveguide formed on a substrate;
a modulation electrode and a conductive region that form a modulation region in the optical waveguide; and
an interconnection pattern electrically connected to the modulation electrode,
the conductive region being formed in an area that excludes a region in which the interconnection pattern overlaps the optical waveguide.

2. An optical semiconductor device comprising:
an optical waveguide that is formed on a substrate;
a plurality of modulation electrodes and a plurality of conductive regions that form a modulation region in the optical waveguide; and
an interconnection pattern that is electrically connected to the modulation electrodes,
the modulation electrodes being electrically separated from one another and corresponding to the conductive regions one by one, and
the conductive regions being electrically separated from one another and formed in an area that excludes a region in which the interconnection pattern overlaps the optical waveguide.

3. The optical semiconductor device as claimed in claim 1 or claim 2, wherein the optical waveguide includes branch waveguides.

4. The optical semiconductor device as claimed in claim 1 or claim 2, wherein the optical waveguide is combined with another optical waveguide at a later stage than the modulation region in a propagation direction of light propagating through the optical waveguide.

5. The optical semiconductor device as claimed in claim 1 or claim 2, wherein the modulation electrode and the conductive region are provided for branch optical waveguides of said optical waveguide.

6. The optical semiconductor device as claimed in claim 5, wherein the conductive region exists under each of the branch optical waveguides.

7. The optical semiconductor device as claimed in claim 1 or claim 2, wherein:
the optical waveguides include branch optical waveguides;
a first part of the interconnection pattern associated to one of the branch optical waveguides is supplied with the modulation signal; and
a second part of the interconnection pattern associated with another one of the branch optical waveguides is supplied with a ground potential.

8. The optical semiconductor device as claimed in claim 7, wherein the first and second part of the interconnection pattern extend outward from an identical side on the substrate.

9. The optical semiconductor device as claimed in claim 8, wherein the modulation region is formed in the optical waveguide located between the first part of the interconnection pattern to which the modulation signal is applied and the second part of the interconnection pattern to which the ground potential is applied.

10. The optical semiconductor device as claimed in claim 2, wherein the conductive regions are electrically separated from one another by at least one of an air gap, an insulting region, and a region with a higher resistance than the conductive regions.

11. The optical semiconductor device as claimed in claim 2, wherein the modulation electrodes are arranged at such intervals that the propagation velocity of a modulation signal propagating through the interconnection pattern is matched with the propagation velocity of light propagating through the optical waveguide.

12. The optical semiconductor device as claimed in claim 1, wherein the optical waveguide is of a ridge type.

13. The optical semiconductor device as claimed in claim 1, wherein the conductive region is formed with a conductor or a semiconductor doped with an impurity.

14. A light phase control device comprising:
an optical waveguide formed on a substrate;
a modulation electrode and a conductive region that form a modulation region in the optical waveguide; and
an interconnection pattern electrically connected to the modulation electrode,
the conductive region being formed in an area that excludes a region in which the interconnection pattern overlaps the optical waveguide, and
a modulation signal being applied to the interconnection pattern, thereby controlling a phase of light propagating through the optical waveguide.

15. A light phase control device comprising:
an optical waveguide formed on a substrate;
a plurality of modulation electrodes and a plurality of conductive regions that form a modulation region in the optical waveguide; and
an interconnection pattern electrically connected to the modulation electrodes,
the modulation electrodes being separated from one another, and corresponding to the conductive regions one by one,
the conductive regions being electrically separated from one another, and being formed in an area that excludes a region in which the interconnection pattern overlaps the optical waveguide, and
a modulation signal being applied to the interconnection pattern, thereby controlling the phase of light propagating through the optical waveguide.

16. A light intensity control device comprising:
a plurality of optical waveguides formed on a substrate;
a modulation electrode and a conductive region that form a modulation region in the optical waveguides; and
an interconnection pattern electrically connected to the modulation electrode,
the conductive region being formed in an area that excludes a region in which the interconnection pattern overlaps the optical waveguides, and
lights entered into the optical waveguides being subjected to phase control in the modulation region, and then being combined.

17. A light intensity control device comprising:
a plurality of optical waveguides formed on a substrate;
a plurality of modulation electrodes and a plurality of conductive regions that form a modulation region in the optical waveguide; and
an interconnection pattern electrically connected to the modulation electrodes,
the modulation electrodes being separated from one another, and corresponding to the conductive regions one by one,
the conductive regions being electrically separated from one another, and being formed in an area that excludes a region in which the interconnection pattern overlaps the optical waveguides, and
lights entered into the optical waveguides being subjected to phase control in the modulation region, and then being combined.

18. A method of producing an optical semiconductor device that includes an optical waveguide formed on a substrate, a modulation electrode and a conductive region for forming a modulation region in the optical waveguide, and an interconnection pattern electrically connected to the modulation electrode,
the method comprising the step of:
forming the conductive region in an area that excludes a region in which the interconnection pattern overlaps the optical waveguide.

19. A method of producing an optical semiconductor device that includes an optical waveguide formed on a substrate, a plurality of modulation electrodes and a plurality of conductive regions for forming a modulation region in the optical waveguide, and an interconnection pattern electrically connected to the modulation electrodes,
the method comprising the step of:
forming the conductive regions in areas electrically separated from one another on the substrate, the areas excluding a region in which the interconnection pattern overlaps the optical waveguide.
